(19) United States
(12) Patent Application Publication
(10) Pub. No.: US 2012/0017148 A1
(43) Pub. Date: Jan. 19, 2012

(54) Navigating Between A Map Dialog And Button Controls Displayed Outside The Map

(75) Inventors: Robert Anthony WATT, Kanata (CA); Raymond Lee CANTON, Kanata (CA); Laura MAHAN, Kanata (CA)

(73) Assignee: RESEARCH IN MOTION LIMITED, Waterloo (CA)

(21) Appl. No.: 13/011,161

(22) Filed: Jan. 21, 2011

Related U.S. Application Data
(60) Provisional application No. 61/364,517, filed on Jul. 15, 2010.

(51) Int. Cl. G06F 3/048

(52) U.S. Cl. 715/708; 715/764

(57) ABSTRACT

A method of interacting with a map displayed on a mobile device entails displaying a map in a map dialog on a display of the mobile device, displaying control buttons on the display but outside the map dialog, and receiving user input to switch between a map manipulation mode, where user input manipulates the map, and a control button mode, where user input enables navigation between the control buttons. In one implementation, switching between the two modes permits the same user interface element to be used for navigation/manipulation of the map and of the control buttons, depending on which mode is activated. In one implementation, clicking the track pad toggles between the map manipulation mode and the control button mode.

### CROSS-REFERENCE TO RELATED APPLICATIONS

This application claims priority from U.S. Provisional Patent Application 61/364,517 filed Jul. 15, 2010.

### TECHNICAL FIELD

The present technology relates to portable electronic devices capable of displaying maps and, in particular, to wireless communications devices with mapping capabilities.

### BACKGROUND

Portable electronic devices or mobile devices such as GPS-enabled wireless communications devices are increasingly popular. One of the popular and useful features on these devices is mapping and GPS-based real-time navigation. In other words, these GPS-enabled mobile devices are able not only to display labelled maps of any requested location but also track and display the current location of the device, thereby enabling navigation and other location-based services.

The ergonomics of how the user interacts with the map displayed onscreen is very important, particularly on a mobile device with its small user interface. This is especially important where a button control, or user interface element, on the device is designated for use for interacting with both the map and with other (non-map) onscreen elements. Accordingly, there is a continued need to improve the mobile device to provide an intuitive and ergonomic user-map interaction interface.

### BRIEF DESCRIPTION OF THE DRAWINGS

Further features and advantages of the present technology will become apparent from the following detailed description, taken in combination with the appended drawings, in which:

FIG. 1 is a schematic depiction of a wireless communications device as an example of a mobile device on which the present technology can be implemented;

FIG. 2 is a flowchart outlining some of the main steps of a method of navigating between a map displayed in a dialog onscreen and a plurality of control buttons displayed onscreen but outside the map dialog;

FIG. 3 depicts an example of a map dialog in an initial state (“inactive focus”) where the focus is initially on the Attach button (i.e. one of the control buttons outside the dialog);

FIG. 4 depicts an example of the same map dialog of FIG. 3 after the focus has been shifted to the map dialog;

FIG. 5 depicts an example of the same map dialog of FIG. 4 after the user has clicked the optical jog pad to enter into the map edit/manipulation mode;

FIG. 6 depicts an example of the same map dialog in map edit mode (interactive state) where the hint overlay has been removed; and

FIG. 7 depicts an example of the same map dialog of FIG. 6 after the user has again clicked on the optical jog pad to return to the control button mode (i.e. the map dialog has returned to inactive focus).

It will be noted that throughout the appended drawings, like features are identified by like reference numerals.

### DETAILED DESCRIPTION

In general, the present technology provides an innovative technique for onscreen navigation between a map dialog displayed onscreen on a mobile device and a plurality of control buttons that are also displayed onscreen but outside the map dialog. Specifically, this technique enables the same user interface element, e.g. an optical jog pad, track pad, or equivalent button, to be used for both map navigation and navigation through the control buttons. The device may be toggled or switched between the map edit mode (or map manipulation mode) and the control button mode. Switching or toggling between these two modes may be done by any suitable predetermined user input. For example, clicking on the optical jog pad may be used as the trigger to switch/toggle between the two modes. Other user input mechanisms such as a dedicated hot key, a sequence of key strokes, a touch-screen gesture, voice command, etc. may be also be used.

Thus, any aspect of the present technology is a method, performed on a mobile device, of navigating between a map dialog displayed onscreen and a plurality of control buttons displayed onscreen but outside the map dialog. The method entails'. This method of interacting with a map displayed on a mobile device entails displaying a map in a map dialog on a display of the mobile device and displaying control buttons on the display but outside the map dialog. The method further entails receiving user input to switch between a map manipulation mode, where user input manipulates the map, and a control button mode, where user input enables navigation between the control buttons.

Another aspect of the present technology is a computer readable medium (or machine readable medium) comprising instructions in code which when loaded into memory and executed on a processor of a mobile device causes the steps of the foregoing method to be performed.

Yet another aspect of the present technology is a mobile device having a memory coupled to a processor for executing a map application on the mobile device, a display for displaying a map dialog containing a map and for displaying a plurality of control buttons outside the map dialog, and a user interface for receiving user input to switch between a map manipulation mode for manipulating the map in the map dialog and a control button mode for navigating between the control buttons. In one implementation, a track pad or optical jog pad is used to scroll or pan the map (when in map manipulation mode) and to navigate through the control buttons (when in control button mode). In this implementation, clicking of the track pad or optical jog pad toggles the focus between the map and the control buttons, i.e. switches the display between map manipulation mode and control button mode.

The details and particulars of these aspects of the technology will now be described below, by way of example, with reference to the attached drawings.

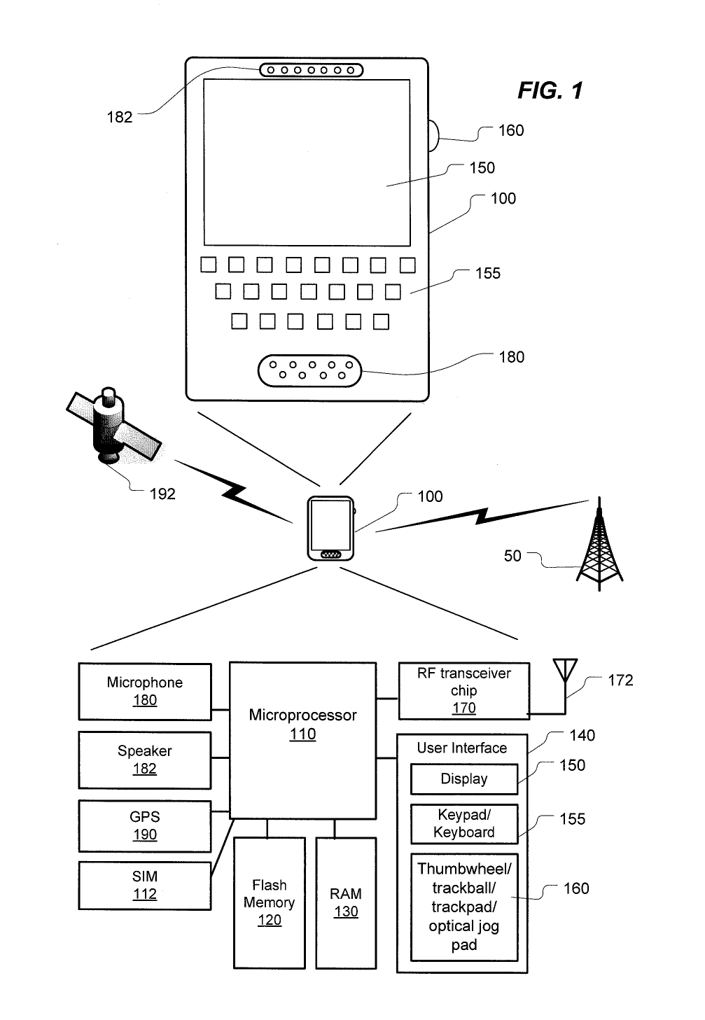

FIG. 1 is a schematic depiction of a wireless communications device 100 as one example of a portable electronic device or mobile device on which the present technology can be implemented. The terms “mobile device” or “wireless communications device” are meant to encompass a broad range of cellular or other portable electronic devices such as, for example, smartphones, cell phones, satellite phones, wireless-enabled personal digital assistants (PDAs), wireless-enabled computing tablets, wireless-enabled laptops, etc.

As shown schematically in FIG. 1, the wireless communications device 100 includes a microprocessor (referred to herein as a “processor”) 110 operatively coupled to memory (Flash Memory 120 and/or RAM 130). The device may include a SIM card 112 or equivalent. The device 100 has a user interface 140 which includes a display (e.g. an LCD screen) 150, a keyboard/keypad 155. A thumbwheel (or trackball or track pad or optical jog pad) 160 may optionally be provided as part of the user interface. Alternatively, the user interface 140 may include a touch screen in lieu of a keyboard/keypad. The wireless communications device 100 includes a radiofrequency (RF) transceiver chipset 170 for wirelessly transmitting and receiving data (e.g. map data) and voice communications, e.g. via a cellular network. The wireless communications may be performed using CDMA, GSM, or any other suitable communications standard or protocol. A microphone 180 and speaker 182 (and/or jack for earphones) are provided for voice communications.

As further depicted in FIG. 1, the wireless communications device 100 may include a GPS chipset 190 (or other position-determining subsystem) to determine the current location of the device from radiofrequency signals emitted by a plurality of orbiting GPS satellites. The GPS chipset thus enables navigation applications to be run on the device.

Although the present disclosure refers to expressly to the “Global Positioning System”, it should be understood that this term and its abbreviation “GPS” are being used expansively to include any satellite-based navigation-signal broadcast system, and would therefore include other systems used around the world including the Beidou (COMPASS) system being developed by China, the multi-national Galileo system being developed by the European Union, in collaboration with China, Israel, India, Morocco, Saudi Arabia and South Korea, Russia's GLONASS system, India's proposed Regional Navigational Satellite System (IRNSS), and Japan's proposed QZSS regional system.

Another sort of position-determining subsystem may be used as well, e.g. a radiolocation subsystem that determines its current location using radiolocation techniques, as will be elaborated below. In other words, the location of the device can be determined using triangulation of signals from in-range base towers, such as used for Wireless E911. Wireless Enhanced 911 services enable a cell phone or other wireless device to be located geographically using radiolocation techniques such as (i) angle of arrival (AOA) which entails locating the caller at the point where signals from two towers intersect; (ii) time difference of arrival (TDOA), which uses multilateration like GPS, except that the networks determine the time difference and therefore the distance from each tower; and (iii) location signature, which uses “fingerprinting” to store and recall patterns (such as multipath) which mobile phone signals exhibit at different locations in each cell. Radiolocation techniques may also be used in conjunction with GPS in a hybrid positioning system.

References herein to “GPS” are meant to include Assisted GPS and Aided GPS.

This novel mobile device 100 has its memory coupled to its processor for executing a map application on the mobile device. The map application is coded to generate the map in a map dialog onscreen as shown by way of example in the appended figures. This novel mobile device includes a display for displaying the map dialog containing the map and for displaying a plurality of control buttons outside the map dialog. The user interface of the device is adapted to receive user input to switch between a map manipulation mode for manipulating the map in the map dialog and a control button mode for navigating between the control buttons.

In one specific implementation, the user interface comprises a track pad, optical jog pad or equivalent for scrolling and panning the map and for navigating between the control buttons, wherein a click of the track pad or optical jog pad triggers switching between the map manipulation mode and the control button mode.

In one specific implementation, the device further displays navigation hints onscreen to indicate how to interact with the map in the map dialog.

In one specific implementation, the device displays a highlighted frame around the map dialog to signify that the track pad or optical jog pad may be clicked to switch into map manipulation mode.

The map data for rendering the map onscreen in the map dialog may be downloaded wirelessly using the radiofrequency transceiver 170 of the device 100 and/or may be preloaded or cached on the device. Map data may be stored permanently in a non-volatile memory such as, for example, ROM, PROM, EPROM, Flash memory. Alternatively, a volatile memory such as, for example, RAM (e.g. DRAM, SRAM) may be used to cache the map data on the device after it is received from an outside source such as a map server.

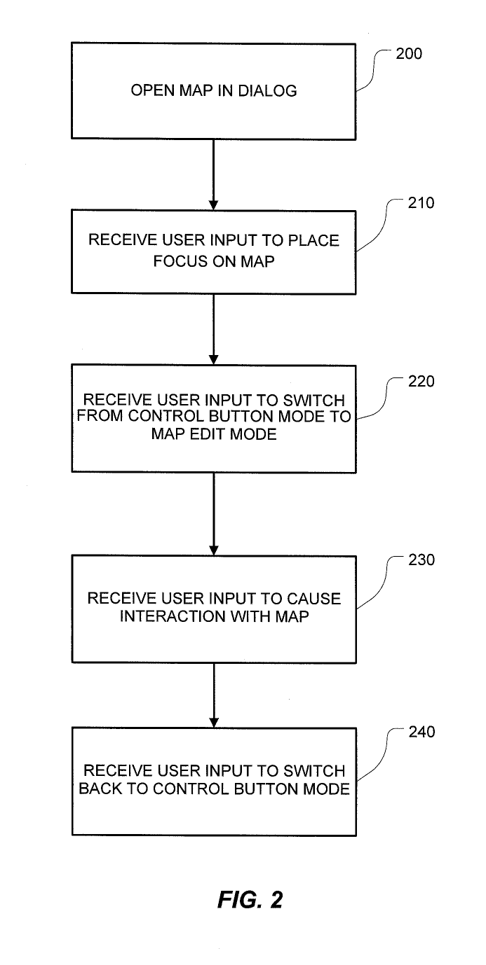

FIG. 2 is a flowchart outlining some of the main steps of a novel method of interacting with a map displayed on a screen of a mobile device. The method, in general terms, entails steps of displaying a map in a map dialog on a display of the mobile device. The map dialog may be a box or window with an optional frame that surrounds the map to clearly delineate the extent of the map. The method also involves displaying one or more control buttons on the display. These control buttons are non-map (or non-manipulating) control buttons in the sense that they do not cause scrolling, panning, zooming or other manipulation or editing of the map. However, these control buttons may interact indirectly with the map in the sense that the control buttons may be used to attach a map data file for sending via e-mail, for example. These control buttons are displayed off the map, i.e. outside the map dialog. Because the map world is navigationally infinite, i.e. it does not have an end and the user can continue to pan or scroll indefinitely around the globe, it is therefore not possible to scroll or pan to the end of the map to exit from the map, as one might be able to do with a finite list or image, for example. Instead, scrolling or panning will continue indefinitely with no apparent means of exiting from the map world. To exit from the map world, it is thus necessary to provide some form of predetermined user input that cause the device to toggle (switch) from the map manipulation mode to the control button mode, i.e. to move between the two otherwise separate worlds (interface domains). Likewise, when operating in the control button mode, there must be a way to exit from the control buttons (control button interface domain) and move to the map (map domain). Accordingly, the novel method further entails receiving user input to switch between a map manipulation mode, where user input manipulates the map, and a control button mode, where user input enables navigation between the control buttons.

In one implementation of this method, as depicted by way of example in FIG. 2, the novel method entails (at step 200) rendering, opening, launching or otherwise activating a map in a map dialog on a display screen of the mobile device. The map may be a vector-based map or a bitmap. The display screen may be touch-sensitive or not, i.e. a regular (non-touch-sensitive screen). At step 210, the device receives user input to place the focus on the map. This may be done by scrolling upward to highlight the dialog box as will be shown and described below. At step 220, the device then receives confirmatory user input to switch from control button mode (inactive focus) to map edit mode (also referred to herein as map manipulation mode or active focus). At step 230, the device receives user input to manipulate or edit (or otherwise interact with the map in the map dialog). In map manipulation mode, the map can be panned, scrolled, zoomed, annotated, etc. and updated as requested within the confines of the dialog. At step 240, the device may receive further input to cause the display to toggle back to the control button mode.

In one implementation of this novel method, the step of receiving selection input to switch between the map manipulation mode and the control button mode comprises receiving a click on a track pad. The track pad is also used for manipulating the map and for navigation between the control buttons. In other words, the track pad is used to navigate between control buttons or other such user interface elements that are presented onscreen outside the map dialog. The track pad is also used to navigate on the map presented inside the map dialog. Clicking of the track pad enables the user to toggle between map manipulation mode and control button mode.

In another implementation of this novel method, the user may use the track pad to highlight the dialog before clicking the track pad to confirm the switch to map manipulation mode.

In another implementation of this novel method, the device also displays navigation hints onscreen to instruct the user how to interact with the map in the map dialog.

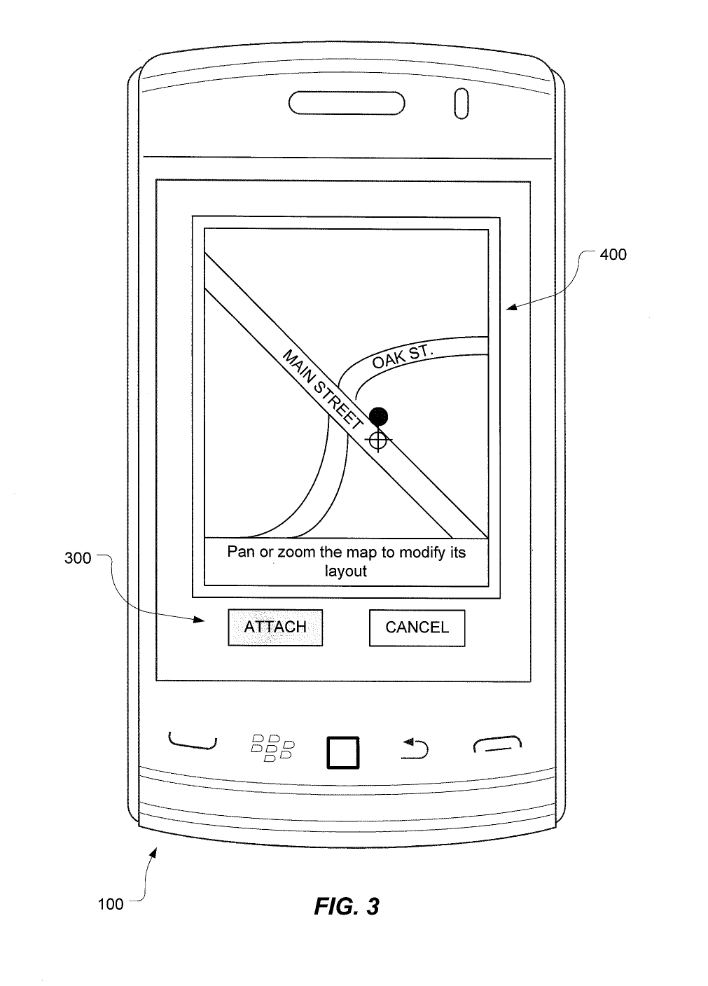

FIG. 3 depicts an example of a map dialog in an initial state (also referred to herein as “inactive focus”) where the focus is initially on the Attach button (i.e. one of the control buttons 300 outside the dialog 400. For greater certainty, the Attach and Cancel buttons are the non-map (or non manipulating) control buttons 300. The dialog, window or box containing the map is the map dialog 400. This figure shows the novel technology implemented on a touch-screen or touch-sensitive device. It should be understood that the novel technology also works on a non-touch device having a track pad or optical jog pad.

In the example presented in FIG. 3, when the dialog opens, the focus is on the Attach button (as a default) for quick completion if the map orientation is acceptable to the user. Overlay hints state that the map can be modified by panning or zooming. Touch-sensitive device users may do this directly. Users of optical jog devices will scroll up to the map.

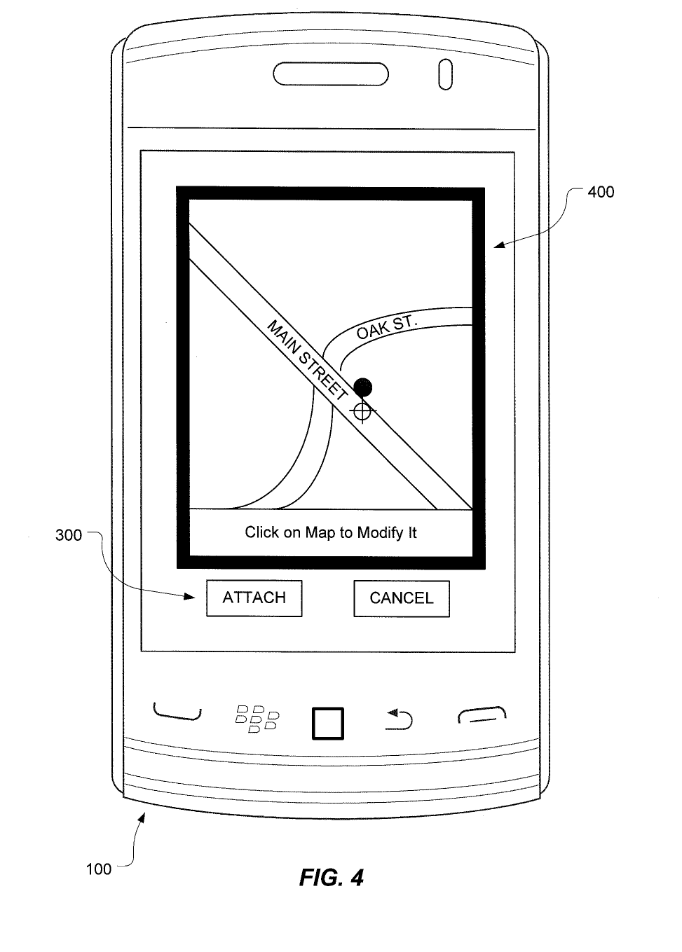

FIG. 4 depicts an example of the same map dialog of FIG. 3 after the focus has been shifted to the map dialog 400 from the external control buttons 300. When the optical jog pad has been used to place the focus on the map dialog, the message/hint changes to indicate that a click is now required to toggle to the map edit mode (map manipulation mode or “edit mode” or “active focus”). The border or frame around the dialog may be highlighted to signal to the user that the dialog has been selected and now requires confirmatory input to confirm the selection.

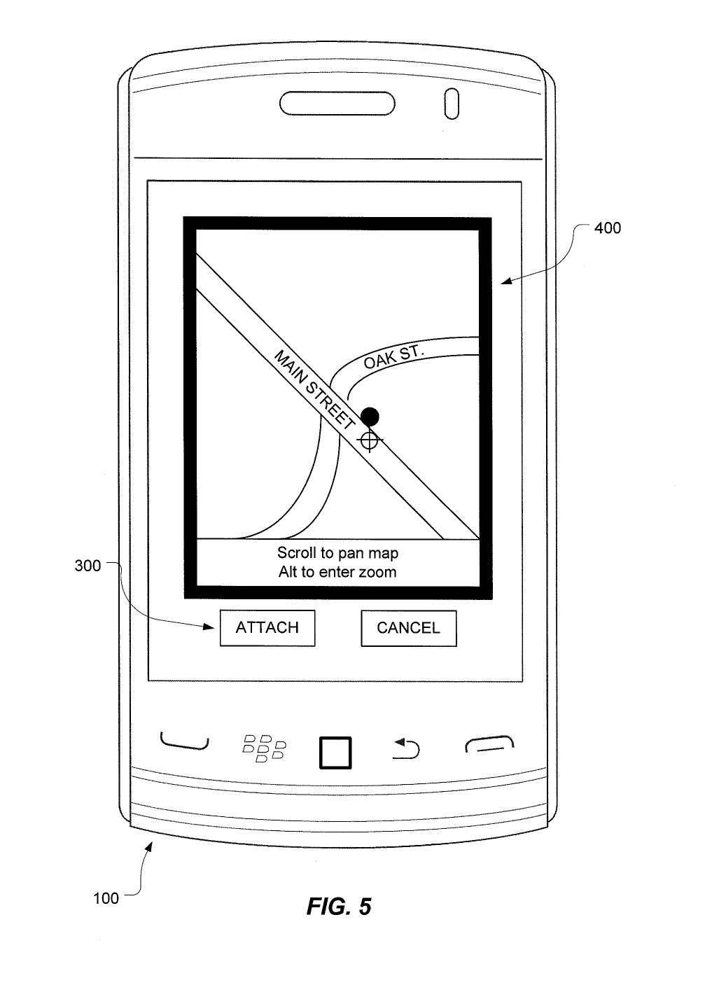

FIG. 5 depicts an example of the same map dialog 400 of FIG. 4 after the user has clicked the optical jog pad to enter into the map edit/manipulation mode. The control buttons 300 now cannot be accessed by accessed by manipulating the optical jog pad. Touching the optical jog pad now only provides user input to the map (e.g. scrolls or pans the map within the map dialog). The control buttons 300 may be greyed out to indicate that they are presently inactive. As further depicted in FIG. 5, a new message/hint/instruction is provided on the overlay to explain to the user how to scroll, pan, zoom, etc.

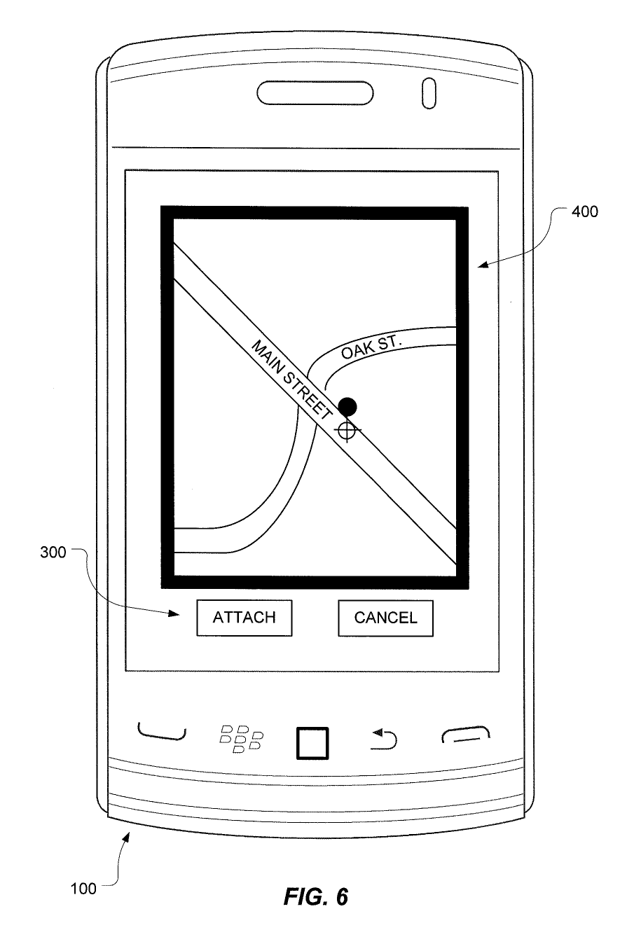

FIG. 6 depicts an example of the same map dialog in map edit mode (interactive state) where the hint overlay has been removed. In one variant, if the optical jog pad or track pad is used and then there is a pause (no further input), a prompt or hint may appear to indicate what the user may next do, e.g. “Click to enter your changes”.

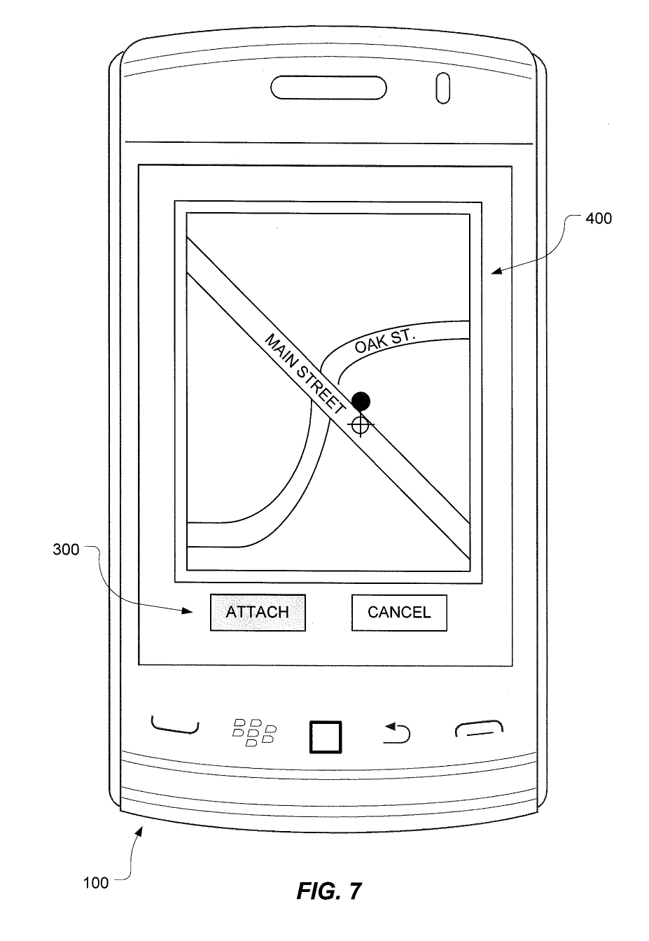

FIG. 7 depicts an example of the same map dialog of FIG. 6 after the user has again clicked on the optical jog pad to return to the control button mode (i.e. the map dialog has returned to inactive focus). In this state, the highlighted frame or border around the map dialog is removed to indicate that the map dialog is no longer in active focus. One of the control buttons, in this example the Attach button, may be highlighted to show that the control button mode is now active (and to further show that the Attach function has been tentatively selected for confirmation by the user).

A settings, preferences or options page or menu may be accessible on the device to configure which predetermined key, button, user interface element, key stroke sequence, touch-sensitive gesture, voice command or other user input that will be defined as the trigger causing the device to toggle between the two modes.

The foregoing method steps can be implemented in hardware, software, firmware or as any suitable combination thereof. The method steps may be implemented as software, as coded instructions stored on a computer readable medium which performs the foregoing steps when the computer readable medium is loaded into memory and executed by the microprocessor of the mobile device.

This new technology has been described in terms of specific implementations and configurations which are intended to be exemplary only. Persons of ordinary skill in the art will appreciate that many obvious variations, refinements and modifications may be made without departing from the inventive concepts presented in this application. The scope of the exclusive right sought by the Applicant(s) is therefore intended to be limited solely by the appended claims.

1. A method of interacting with a map displayed on a mobile device, the method comprising:
displaying a map in a map dialog on a display of the mobile device;
displaying control buttons on the display but outside the map dialog; and
receiving selection input to switch between a map manipulation mode, where subsequent input manipulates the map, and a control button mode, where subsequent input enables navigation between the control buttons.

2. The method as claimed in claim 1 wherein the receiving selection input to switch between the map manipulation mode and the control button mode is a click of a track pad where the track pad is also used for subsequent input for manipulating the map and for navigation between the control buttons.

3. The method as claimed in claim 2 wherein the receiving of selection input to switch between the map manipulation mode and the control button mode comprises using the track pad to place a focus on the map dialog before clicking the track pad.

4. The method as claimed in claim 1 further comprising displaying navigation hints onscreen to indicate how to interact with the map in the map dialog.

5. A computer-readable medium comprising instructions in code which when loaded into memory and executed on a processor of a mobile device is adapted to perform acts of:
displaying a map in a map dialog on a display of the mobile device;
displaying control buttons on the display but outside the map dialog; and
receiving input to switch between a map manipulation mode, where subsequent input manipulates the map, and a control button mode, where subsequent input enables navigation between the control buttons.

6. The computer-readable medium as claimed in claim 5 comprising code that causes a switch between the map manipulation mode and the control button mode on receipt of a click of a track pad where the track pad is also used for manipulating the map and for navigation between the control buttons.

7. The computer-readable medium as claimed in claim 5 wherein the receiving of input to switch between the map manipulation mode and the control button mode comprises using the track pad to place a focus on the map dialog before clicking the track pad.

8. The computer-readable medium as claimed in claim 5 further comprising code for displaying navigation hints onscreen to indicate how to interact with the map in the map dialog.

9. A mobile device comprising:
a memory coupled to a processor for executing a map application on the mobile device;
a display for displaying a map dialog containing a map and for displaying a plurality of control buttons outside the map dialog; and
a user interface for receiving input to switch between a map manipulation mode for manipulating the map in the map dialog and a control button mode for navigating between the control buttons.

10. The device as claimed in claim 9 wherein the user interface comprises a track pad for scrolling and panning the map and for navigating between the control buttons, wherein a click of the track pad triggers switching between the map manipulation mode and the control button mode.

11. The device as claimed in claim 9 further comprising displaying navigation hints onscreen to indicate how to interact with the map in the map dialog.

12. The device as claimed in claim 10 further comprising displaying a highlighted frame around the map dialog to signify that the track pad may be clicked to switch into map manipulation mode.
